(19) United States
(12) Patent Application Publication
(10) Pub. No.: US 2006/0063060 A1
(43) Pub. Date: Mar. 23, 2006

(54) Graphite/metal foil/polymer substrate laminate for low contact resistance bipolar plate application

(76) Inventor: Michael W. Murphy, Manchester, NY (US)

Correspondence Address: HARNESS, DICKEY & PIERCE, P.L.C., P.O. BOX 828, BLOOMFIELD HILLS, MI, 48303, US

(21) Appl. No.: 10/947,569

(22) Filed: Sep. 22, 2004

(51) Int. Cl. B32B 37/00

(52) U.S. Cl. 429/38; 156/252; 156/290

(57) ABSTRACT

A separator plate for a PEM fuel cell and a method of making the same includes providing a sheet of material having through plane passages formed therein. A sheet of graphite is placed on each of a first face and a second face of the sheet of material to form a laminated member. Compressive force is applied onto the laminated member. First portions of the graphite are extruded to flow into the through plane passages. An array of electrically conductive pathways through the sheet are created. Second portions of graphite are bonded to each of the first face and the second face.

### FIELD OF THE INVENTION

The present invention relates to PEM fuel cells and more particularly to a separator plate having reduced contact resistance.

### BACKGROUND OF THE INVENTION

Fuel cells have been used as a power source in many applications. For example, fuel cells have been proposed for use in electrical vehicular power plants to replace internal combustion engines. In proton exchange membrane (PEM) type fuel cells, hydrogen is supplied to the anode of the fuel cell and oxygen is supplied as the oxidant to the cathode. PEM fuel cells include a membrane electrode assembly (MEA) comprising a thin, proton transmissive, non-electrically conductive, solid polymer electrolyte membrane having the anode catalyst on one face and the cathode catalyst on the opposite face. The MEA is sandwiched between a pair of non-porous, electrically conductive elements or separator plates which (1) serve as current collectors for the anode and cathode, and (2) contain appropriate channels and/or openings formed therein for distributing the fuel cell's gaseous reactants over the surfaces of the respective anode and cathode catalysts.

The term “fuel cell” is typically used to refer to either a single cell or a plurality of cells (stack) depending on the context. A plurality of individual cells are typically bundled together to form a fuel cell stack and are commonly arranged in electrical series. Each cell within the stack includes the membrane electrode assembly (MEA) described earlier, and each such MEA provides its increment of voltage. A group of adjacent cells within the stack is referred to as a cluster.

With any electrical circuit element, the element's ability to carry current is always reduced from ideal by a loss factor, i.e. the element's resistance. In a typical separator plate, or bi-polar plate as referred to in a back to back orientation, there are two losses- one due to the bulk resistance of the plate and another due to the contact resistance with the adjacent current collector/MEA. The electrically conductive separator plates are typically made of metal such as stainless steel to serve as current collectors. While such metallic materials present favorable conductive properties, they also present unfavorable contact resistance across the plane of the plate.

### SUMMARY OF THE INVENTION

A separator plate for a PEM fuel cell and a method of making the same includes providing a sheet of material having through plane passages are formed therein. A sheet of graphite is placed on each of a first face and a second face of the sheet of material to form a laminated member. Compressive force is applied onto the laminated member. First portions of the graphite are extruded to flow into the through plane passages. An array of electrically conductive pathways through the sheet are created. Second portions of graphite are bonded to each of the first face and the second face.

According to other features, adhesive is applied to each of the first and second faces of the sheet. The adhesive includes thermally-activated adhesive bonding the graphite to each of the first and second faces upon application of the compressive force. The sheet of material includes a polymeric substrate such as polyimide. Forming the passages through the sheet of material includes removing about 40% of the sheet of material. Placing the graphite includes placing sheets of graphite, each of which are between about five to ten times as thick as the sheet of material. Applying compressive force includes roll bonding the respective sheets of graphite to the sheet of material. The method further includes forming flow fields in said laminated member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an isometric exploded view of a fuel cell in a PEM fuel cell stack;

FIG. 2 is a sectional view of a separator plate according to the present teachings;

FIG. 3 is a perspective view of a substrate used in accordance to the present teachings;

FIG. 4 is a perspective view of the substrate of FIG. 3 shown with thermally activated adhesive applied to opposite faces;

FIG. 5 is a perspective view of the substrate of FIG. 4 shown perforated across its plane;

FIG. 6 is a perspective view of the substrate of FIG. 5 shown with graphite applied to the opposite faces and a compression force applied thereto; and

FIG. 7 is a process diagram illustrating steps for making a separator plate according to the present invention.

### DETAILED DESCRIPTION OF THE PREFERRED EMBODIMENTS

The following description of the preferred embodiment(s) is merely exemplary in nature and is in no way intended to limit the invention, its application, or uses.

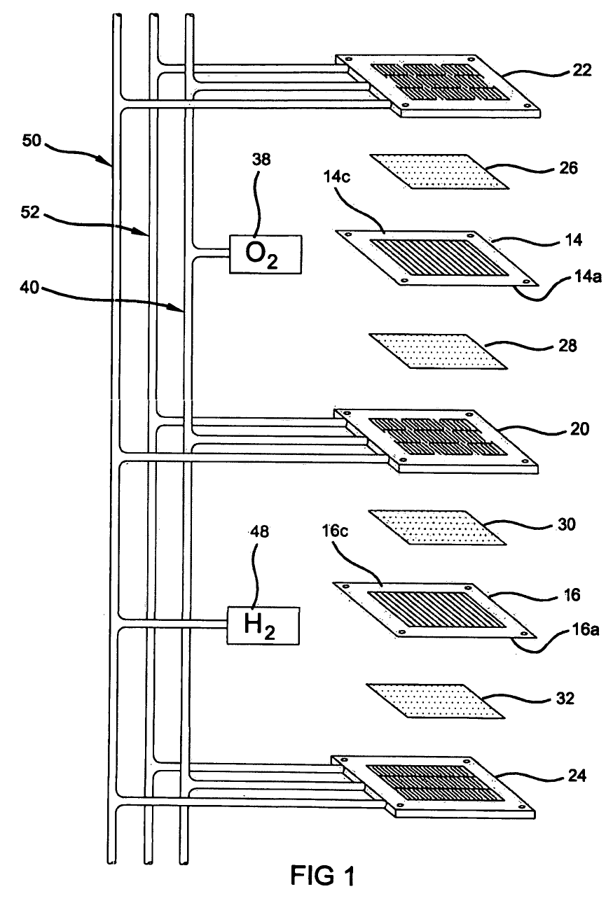

FIG. 1 schematically depicts a partial PEM fuel cell stack 10 having membrane-electrode-assemblies (MEAs) 14, 16 separated from each other by a non-porous, electrically-conductive bipolar plate 20. The MEAs 14 and 16 and bipolar plate 20 are stacked together between non-porous, electrically-conductive, bipolar plates 22 and 24. Porous, gas permeable, electrically conductive sheets or diffusion media 26, 28, 30 and 32 press up against the electrode faces of the MEAs 14 and 16 and serve as primary current collectors for the electrodes. The diffusion media 26, 28, 30 and 32 also provide mechanical supports for the MEAs 14 and 16, especially at locations where the MEAs are otherwise unsupported in the flow field. Suitable diffusion media include carbon/graphite paper/cloth, fine mesh noble metal screens, open cell noble metal foams, and the like which conduct current from the electrodes while allowing gas to pass therethrough.

Bipolar plates 22 and 24 press up against the primary current collector 26 on the cathode face 14c of the MEA 14 and the primary current collector 32 on the anode face 16a of the MEA 16. The bipolar plate 20 presses up against the primary current collector 28 on the anode face 14a of the MEA 14 and against the primary current collector 30 on the cathode face 16c of the MEA 16. An oxidant gas such as oxygen or air is supplied to the cathode side of the fuel cell stack 10 from a storage tank 38 via appropriate supply plumbing 40. Similarly, a fuel such as hydrogen is supplied to the anode side of the fuel cell stack 10 from a storage tank 48 via appropriate plumbing 50.

In a preferred embodiment, the oxygen tank 38 may be eliminated, and air supplied to the cathode side from the ambient. Likewise, the hydrogen tank 48 may be eliminated and hydrogen supplied to the anode side from a reformer which catalytically generates hydrogen from methanol or a liquid hydrocarbon (e.g., gasoline). Exhaust plumbing 52 for the H₂ and O₂/air sides of the MEAs is also provided for removing H₂-depleted anode gas from the anode flow field and O₂-depleted cathode gas from the cathode flow field. Although the exhaust plumbing 52 is shown as a single pipe, it will be appreciated that a distinct pipe may be provided for exhausting each gas.

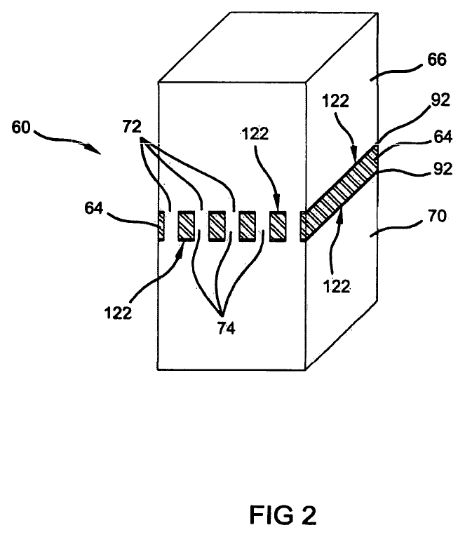

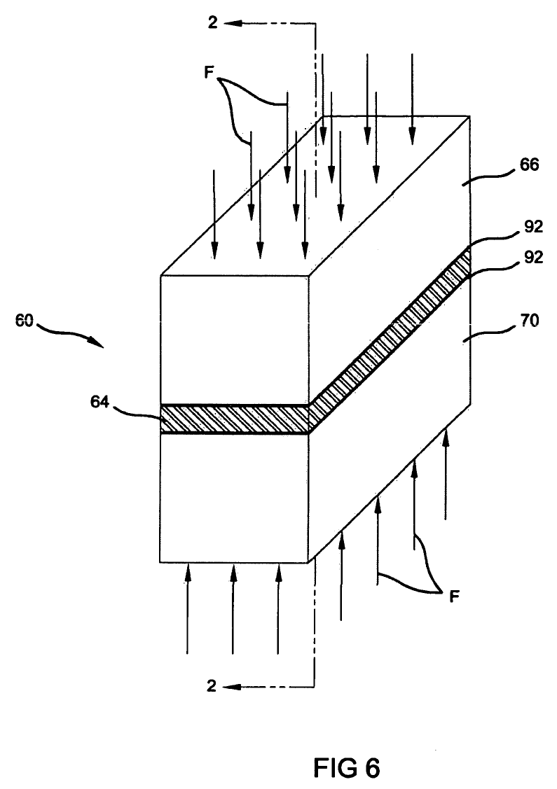

With reference now to FIGS. 2-6, a separator plate 60 according to the present invention will be described in greater detail. The separator plate 60 is configured to carry one of the reactant gases to a respective face of the MEA 16. It will be appreciated that each bipolar plate 20, 22 and 24 comprise two separator plates 60 lying in a back-to-back orientation. The separator plate 60 according to the present teachings provides a laminated graphite polymer substrate having discrete conductive pathways through it. More specifically, the separator plate 60 includes a gas impermeable, polymeric substrate 64 such as polyimide. The polymeric substrate is preferably about 0.002″ thick. A suitable polyimide material includes Kapton® manufactured by the E.I. DuPont Corporation. The polymeric substrate 64 is laminated with first and second sheets of graphite 66 and 70 on opposite faces. The graphite layers 66, 70 are preferably on the order of approximately five to ten times thicker than polyimide substrate 64. Thus, the polymeric substrate provides a sheet of material which is non-conductive but more importantly functions as a support substrate in the separator plate 60 having adequate mechanical strength for ease in handling during manufacture and assembly. In this manner, the present invention takes advantage of the use of graphite to achieve the necessary conductivity without the brittleness associated with a pure graphite sheet compared with a graphite/polymer laminate. It will also be appreciated that the separator plate 60 illustrated in FIGS. 2 and 6, is shown prior to forming flow field channels as shown on the bipolar plates 20, 22 and 24 in FIG. 1.

As will be described in detail below, the graphite 66, 70 is initially located onto opposite faces of the polymeric substrate 64 and subsequently subjected to a pressure application. The material properties of graphite allow the graphite to also flow into passages or perforations 72 across the plane of the polymeric substrate 64 during the pressure application. The graphite extending through the perforations 72 forms the discrete conductive pathways or pillars (FIG. 2) 74 through the polymeric substrate 64 to provide electrical communication between adjacent MEAs 14 and 16. The end result provides a separator plate 60 having high strength, provided in part by the polymeric substrate 64, and low contact resistance, provided in part by the graphite layers 66, 70.

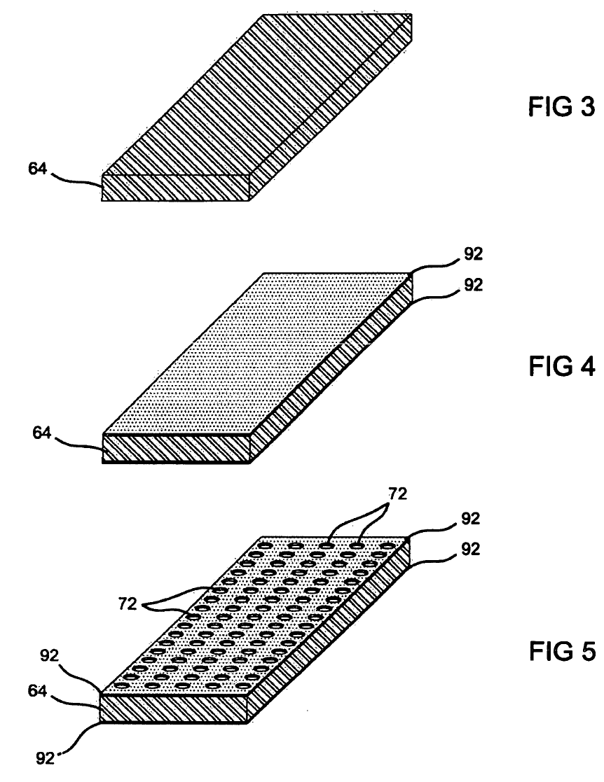

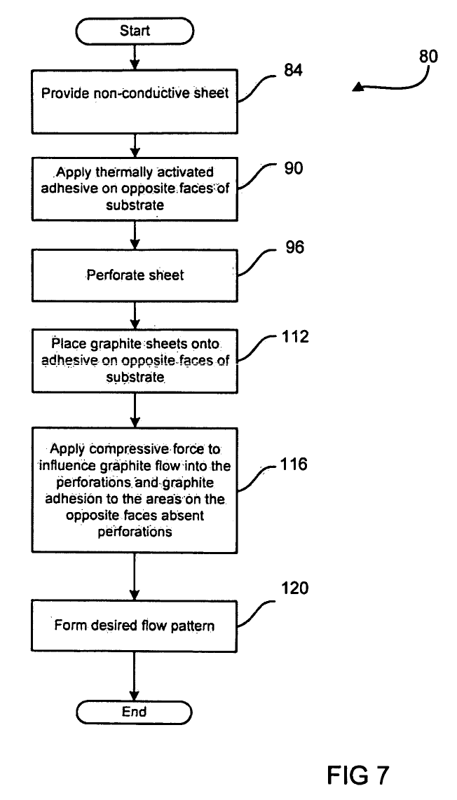

With continued reference to FIGS. 2-6, and further reference to FIG. 7, a method of making the separator plate 60 will be described. A method of making the separator plate 60 according to the present teachings is illustrated in a process chart shown in FIG. 7 and referred generally at reference 80. In step 84, the polymeric substrate 64 is provided (FIG. 3). In step 90, a thermally activated, dry adhesive 92 is applied to opposite surfaces of the polymeric substrate 64 (FIG. 4). In step 96, the substrate 64 is perforated across its plane to form the perforations 72 (FIG. 5). The perforations 72 may be formed by any suitable machining operation. The perforations 72 may remove about 30% to 50% of the material from the substrate 64, and preferably 40% of the substrate 64 is removed. The perforations 72 are shown as having a generally cylindrical configuration which simplifies the machining operations necessary for forming. However, it will be appreciated that the size, shape, density, distribution and location of the perforations 72 (and resulting graphite pillars 74 extending therethrough) within the separator plate 60 may be selected in accordance with the specification and operational parameters of a given fuel cell application.

The graphite sheets of material 66, 70 are then placed across the opposite faces of the substrate 64 in step 112 (FIG. 6). The graphite sheets 66, 70 are preferably about 0.010″ thick. However, as described above, the graphite sheets 66, 70 may be on the order of five to ten times thicker than the polymeric substrate 64, but may also have other thicknesses as dictated by the requirements of a give application and in particular the bulk resistance requirements. Of note, because the dry adhesive 92 is thermally activated, the graphite sheets 66, 70 do not adhere to the substrate 64 at this time. In step 116, the polymeric substrate 64 having the graphite sheets 66, 70 on opposite faces is placed in compression (designated at arrows F in FIG. 6) such as by a roller press assembly. The compressive force exerted onto the respective graphite sheets 66, 70 causes the graphite to flow or extrude into the perforations 72 across the substrate 64 (FIG. 2). Furthermore, the thermally activated adhesive 92 bonds the remaining graphite to the opposite faces of the polymeric substrate 64 absent the perforations (designated at 122, FIG. 2). The desired flow pattern is finally formed in step 120 (not specifically shown), such as by a stamping operation for example, across the plane of the material.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A method of making a separator plate for a PEM fuel cell comprising:
providing a sheet of material;
forming through plane passages in said sheet of material;
placing a sheet of graphite on each of a first face and a second face of said sheet of material to form a laminated member; and
applying compressive force onto said laminated member, thereby extruding first portions of said graphite to flow into said through plane passages and creating an array of electrically conductive pathways through said sheet, and second portions of graphite to bond to each of said first face and said second face.

2. The method of claim 1, further comprising applying adhesive to each of said first and second faces of said sheet.

3. The method of claim 2 wherein applying adhesive includes applying a thermally-activated adhesive, said thermally-activated adhesive bonding said graphite to each of said first and second faces upon application of said compressive force.

4. The method of claim 1 wherein providing said sheet of material includes providing a polymeric substrate.

5. The method of claim 4 wherein said polymeric substrate comprises polyimide.

6. The method of claim 1 wherein forming passages through said sheet of material includes removing about 40% of said sheet of material.

7. The method of claim 1 wherein placing a sheet of graphite includes placing sheets of graphite, each of which are between about five to ten times as thick as said sheet of material.

8. The method of claim 1 wherein applying compressive force includes roll bonding said respective sheets of graphite to said sheet of material.

9. The method of claim 1, further comprising forming flow fields in said laminated member.

10. A method of making a separator plate for a PEM fuel cell comprising:
perforating a non-conductive substrate to form a set of perforations extending through said substrate from a first face to a second face of said substrate;
locating a first sheet of graphite in contact with said first face to form a laminated member;
compressing said laminated member so as to extrude first portions of said first graphite sheet through said set of perforations; and
bonding second portions of said first graphite sheet to said first face.

11. The method of claim 10, further comprising locating a second sheet of graphite in contact with said second face.

12. The method of claim 10, further comprising applying adhesive to each of said first and second faces of said substrate.

13. The method of claim 11 wherein compressing said laminated member includes extruding said first and second graphite sheets through said perforations while applying compressive force to said first and second graphite sheets.

14. The method of claim 10 wherein perforating a non-conductive substrate includes removing about 40% of said non-conductive substrate.

15. The method of claim 10 wherein applying compressive force includes roll bonding said respective sheets of graphite to said substrate.

16. The method of claim 10 wherein said substrate includes a polymeric substrate.

17. The method of claim 16 wherein said polymeric substrate comprises polyimide.

18. The method of claim 11 wherein locating first and second graphite sheets includes placing sheets of graphite, each of which are between about five to ten times as thick as said substrate.

19. The method of claim 10 further comprising forming flow fields in said laminated member.

20. A separator plate for a PEM fuel cell comprising:
a non-conductive substrate material having a plurality of perforations extending between a first and second face;
a layer of graphite disposed across each of said first and second faces defining a laminated member;
graphite extruded through said plurality of perforations and operable to form an electrical communication between said first and second face; and
a flow field geometry formed in said laminated member.

21. The separator plate of claim 20 wherein said non-conductive substrate comprises a polymeric material.

22. The separator plate of claim 21 wherein said polymeric material comprises polyimide.
